(19) United States
(12) Patent Application Publication
(10) Pub. No.: US 2019/0217263 A1
(43) Pub. Date: Jul. 18, 2019

(54) Suckabucket

(71) Applicant: Robert Elee Scarborough, Kent, WA (US)

(72) Inventor: Robert Elee Scarborough, Kent, WA (US)

(21) Appl. No.: 15/871,310

(22) Filed: Jan. 15, 2018

(51) Int. Cl. B01F 15/00; B01F 3/12

(52) U.S. Cl. CPC B01F 15/00961; B01F 3/12

(57) ABSTRACT

This invention (FIG. 1) was conceived out of necessity to control hazardous conditions created while mixing materials like concrete or mortar in containers (1) such as a three gallon or five gallon bucket. The invention (2) is a vacuum attachment which produces a low pressure zone within the bucket when a vacuum is applied to the outlet port (3) of the invention that will keep dust and other airborne material from leaving the interior of the invention through the top of the opening (4). It consists of a funnel shaped opening (4) on the top and a channel around the underside of the funnel leading to the vacuum attachment opening (3), which creates high and low pressure zones, which controls the release of particulate into the atmosphere.

### FIELD OF THE INVENTION

The invention was conceived to provide a way to protect workers and others in the area where work is being performed, from the suspended particles in the atmosphere, while mixing products together. This Invention will help many different workers in the world by providing a product that will give them an additional protection from the ill effects of airborne hazards.

### BACKGROUND OF THE INVENTION

Workers often need to mix products in buckets or containers. The resulting process can put the person at risk of airborne particles. The inventor was pondering this idea, and started thinking about different ways to control the dust. Workers were trying to set a vacuum hose near the edge of the bucket but this did not effectively control the dust. The inventor drew up his idea and experimented with a prototype and proved his theory that by creating a venturi while isolating the vacuum attachment point, the worker was able to effectively control the airborne dust.

### SUMMARY AND OBJECT OF THE INVENTION

The invention FIG. 1 (2) is fitted to set on top of the container FIG. 1 (1) to be used for mixing, and a vacuum hose FIG. 1(5) is attached at the attachment point FIG. 1 (3) of the invention. Once the vacuum FIG. 1 (7) is properly fitted and turned on, the worker adds the mixtures to the container through the top of the invention FIG. 1 (4), and then proceeds to mix the contents with a mixing took, like a paddle bit and drill motor or trowel. When the proper mixture is attained, and the worker confirms the airborne contaminants have been removed, the worker pulls the invention FIG. 1 (2) off the bucket FIG. 1(1) and is able to install their mixture.

### BRIEF DESCRIPTION OF THE DRAWINGS

FIG. 1 shows the invention (2) sitting on a 3 or 5 gallon bucket (1), and a shop vacuum hose (5) attached to the outlet port (3) of the invention. It also shows a typical shop vacuum (7).

FIG. 2 shows a cross sectional view from the side of the invention. The funnel inlet (1) the outlet port (2) with the 2 stage 1¾″ and 2¼″ connection point for the vacuum hose. The base (3) of the invention is designed to rest on top of a bucket or container.

FIG. 3 shows a side perspective view of the invention with the inlet funnel (1), the bottom of the inlet funnel (2), the bucket interface groove (3) and the outlet channel (4), which leads to the outlet port (5).

### DETAILED DESCRIPTION OF THE PRESENT INVENTION

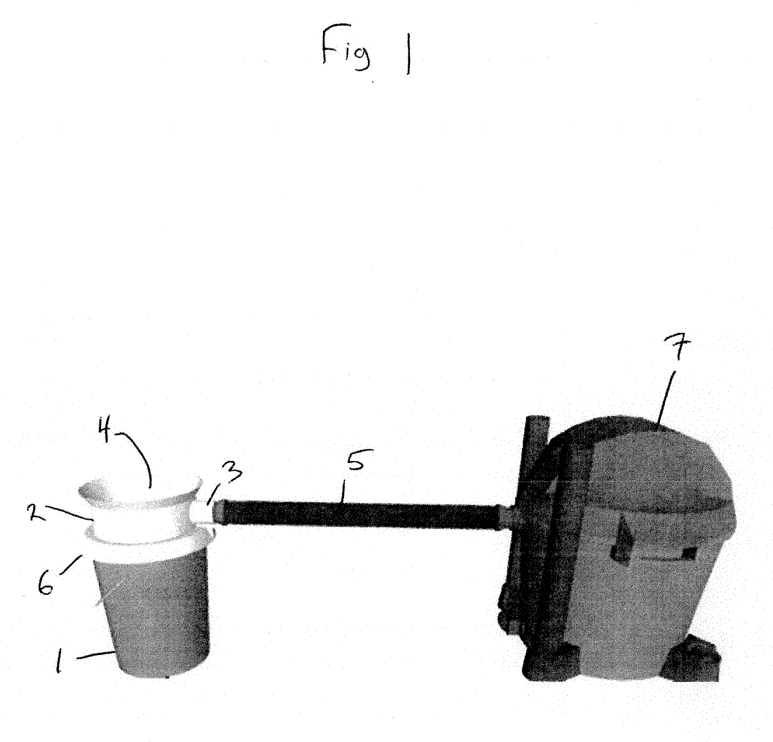

FIG. 1 The invention (2) consists of a funnel shaped opening (4) in the top of the invention, where the product is poured into. As the product enters this opening, the narrowing of the opening caused both the material and the air to increase in speed. The interior develops a low pressure zone by attachment of a shop vacuum (7), which is attached at the inventions outlet port (3) via the vacuum cleaner hose (5). The invention is placed on the mixing container, usually a 3, 5 or 7 gallon bucket (1). The bucket interface groove (6) makes contact with the bucket (1) and the static pressure of the invention resting on the bucket is sufficient to seal them when the vacuum is applied. The worker can pour the material, add mixtures, and water or other required liquid into the inlet funnel (4). They next will typically use a paddle bit and drill motor to mix the materials in the low pressure zone of the interior of the bucket through the inlet funnel (4). Once the desired consistency is achieved, the invention (2) can be lifted off of the bucket (1) and the material can be safely used.

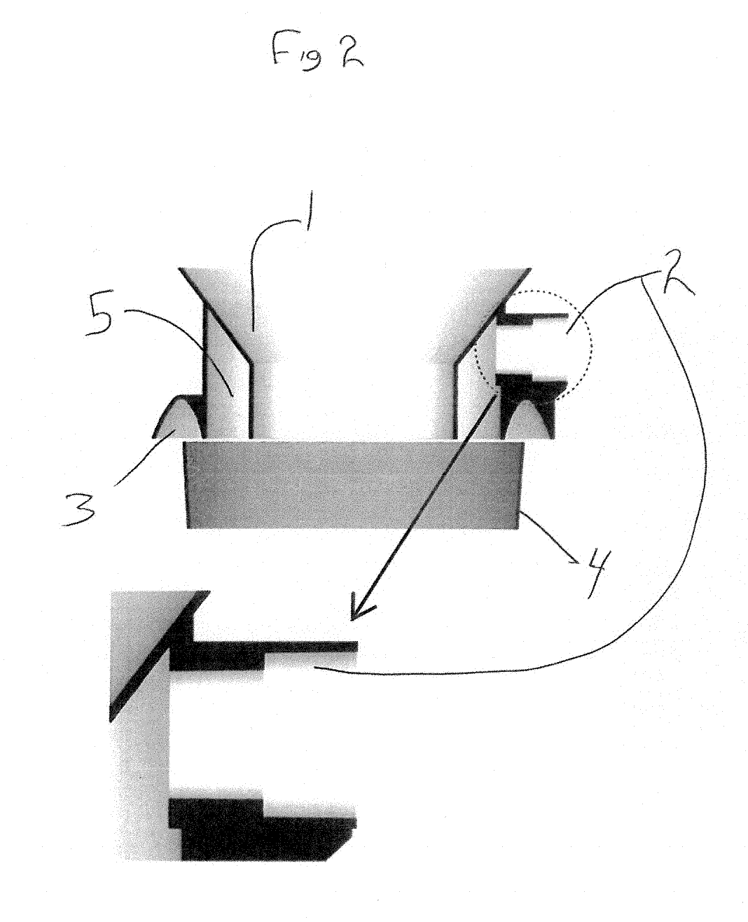

FIG. 2 shows a cross sectional view from the side of the invention. The funnel inlet (1) Where material and the mixing tool will be introduced into the bucket. The outlet channel (5) leads to the outlet port (2) with the two stage connection point for to accommodate either 1¾″ or 2¼″ vacuum hoses. The interface groove (3) of the invention is designed to rest on top of a bucket (4)

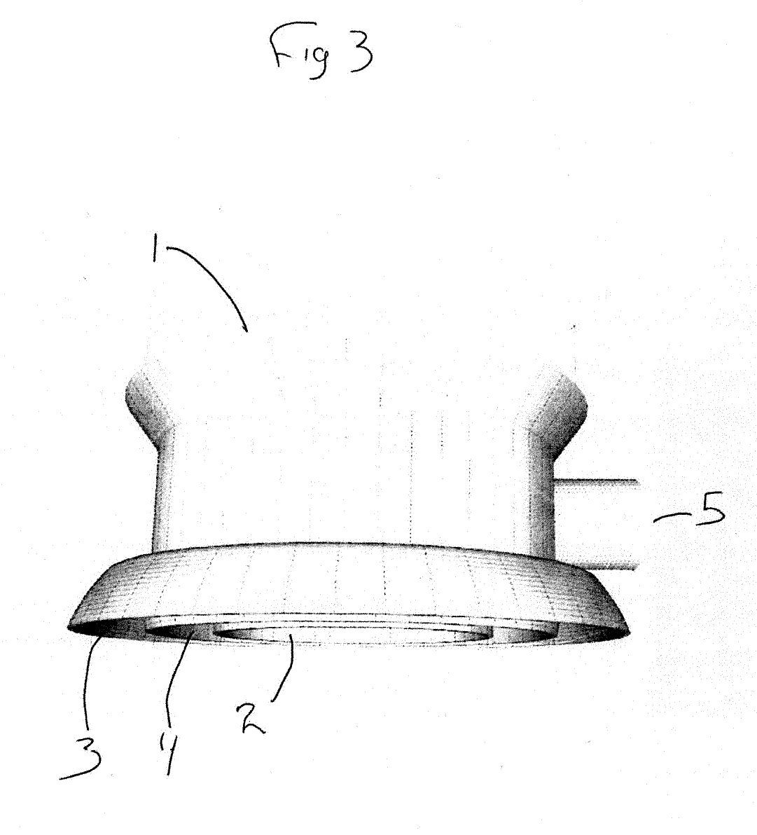

FIG. 3 shows a side perspective view of the invention with the inlet funnel (1), the bottom of the inlet funnel (2), the bucket interface groove (3) and the outlet channel (4), which leads to the outlet port (5).

We claim:

1. Normally a worker would mix product in a 5 gallon bucket or other container and the resulting process would cause dust to become airborne. The dust could contain particles what are harmful if eaten or breathed into the mouth nose and lungs. By using this product it helps reduce the propensity of exposure as explained in the next 2 sentences. This embodiment will cause a low pressure zone where airborne hazards can be effectively controlled and drawn into a properly prepared hepa vacuum while allowing the worker to mix product components together in the bucket. The worker pours the add mixtures into the container by pouring them through the funnel shaped opening (FIG. 1 item 4) then is able to lower their paddle bit into the opening and mix the product to desired consistency while being protected from airborne particles by the appliance.

2. Workers need to clean items which contain harmful particles. They are able to use this product in addition to the bucket and hepa vacuum to safely clean items not limited to filters tools and parts. This embodiment allows workers to lower said items into the interior of the bucket through the opening of the appliance (FIG. 1 item 4) and clean their item. When their item is clean they simply lift out their item through said opening.
